(19) United States
(12) Patent Application Publication
(10) Pub. No.: US 2015/0288790 A1
(43) Pub. Date: Oct. 8, 2015

(54) Management of Contact Information

(71) Applicant: TRUPHONE LIMITED, London (GB)

(72) Inventors: James Tagg, Kent (GB); Edward Thomas Guy, III, Chatham, NJ (US); Adam Linford, London (GB)

(21) Appl. No.: 14/440,557

(22) PCT Filed: Nov. 6, 2013
(86) PCT No.: PCT/GB2013/052911

§ 371 Date: May 4, 2015

(30) Foreign Application Priority Data
Nov. 6, 2012 (GB) 1219931.1

(51) Int. Cl. H04M 1/2745

(52) U.S. Cl. CPC H04M 1/274583; H04M 1/274508; H04M 1/27455

(57) ABSTRACT

A method of ordering contact information for a communications device comprises the following steps. Contact information is associated with a plurality of events associated with the communications device. A contact interaction history is determined from the plurality of events and associated contact information. Contact information is ordered on the basis of the contact interaction history. A suitable system, in which some or all of these steps may be carried out remotely from the communications device, is also described. An alternative method is described which involves determining a current communications device state and ordering the contact information for presentation in dependence on one or more variables of the current communications device state.

### FIELD OF INVENTION

The invention relates to management and presentation of contact information, particularly in relation to the contacts indicated in a mobile device. An exemplary implementation is the phone book of a mobile telephone.

### BACKGROUND TO THE INVENTION

Mobile phones are ubiquitous devices in our life and phoning people with these devices is one of our most common actions. Little innovation in the way you find and phone someone from your mobile phone has occurred in recent years. Typically an address book application for a mobile phone provides an alphabetical list, with choices only constrained as the user starts to enter contact details.

### SUMMARY OF THE INVENTION

In one aspect, the invention provides a method of presenting contact information to a user of a communications device, comprising: determining a current communications device state; and ordering the contact information for presentation in dependence on one or more variables of the current communications device state.

In a further aspect, the invention provides a method of ordering contact information for a communications device comprising: associating contact information with a plurality of events associated with the communications device; determining contact frequency information from the plurality of events and associated contact information; and ordering contact information on the basis of the contact frequency information. Preferably, the ordering is also associated with a current communications device state, in which case the contact frequency information may comprise information derived from variables of the communications device state.

In a preferred embodiment, the communications device is a mobile communications device, such as a mobile telephone. The variables of the communications device state may include current device location, current time of day, and recent call history (for example, contacts communicated with by of any of telephone call, or email, or message, or social network, within the last seven days), or application invoking the contact information.

In a further aspect, the invention provides a system adapted to implement such presentation of contact information to a user of a communications device. In preferred embodiments, this system comprises a client/server arrangement with the communications device acting as a client in communication with a remote server. In other embodiments, the whole system is implemented on the communications device.

This approach improves on the way you find people within your phone book and contact them quickly and efficiently by presenting more likely communication target contacts first. The technology may be implemented in an application that runs on a mobile device such as a mobile phone. Optionally, the application communicates with a server to sort and list contacts that the user is likely to want to communicate with using state information of the mobile device such as recent call history, frequency of calling over time, device location and presence information.

The system may comprise a server that resides in the Internet ‘cloud’ and an application that runs on a device, in most implementations mobile but in some implementations this may be a fixed device. The client optionally synchronizes the contact book and history with the server. An algorithm then runs on the client or service to examine the most common calls made and the most recent calls made as well as other factors.

On a device that is sandboxed, the server can provide information for the client that the client would otherwise not have.

Specific embodiments of the invention will now be described, by way of example, with reference to the accompanying drawings, of which:

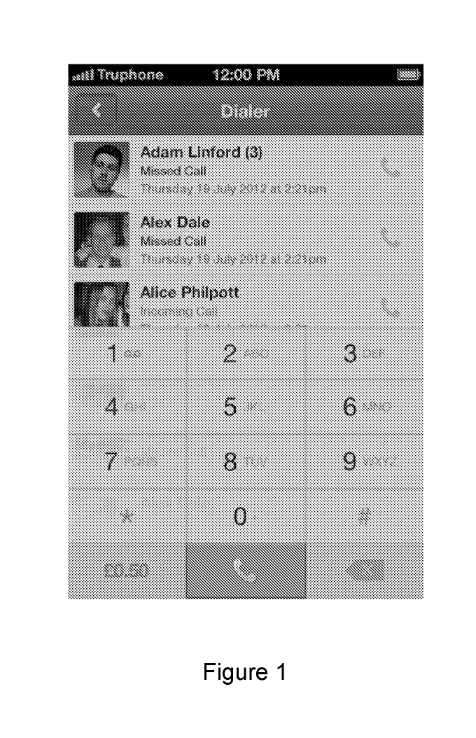

FIG. 1 shows a dialer with “frequent” contacts displayed in accordance with embodiments of the invention;

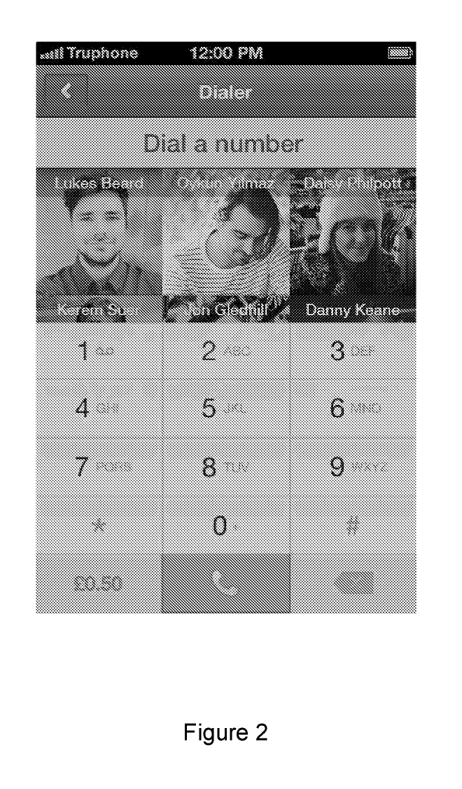

FIG. 2 shows a dialer with “frequent” contacts displayed in accordance with a further embodiment of the invention;

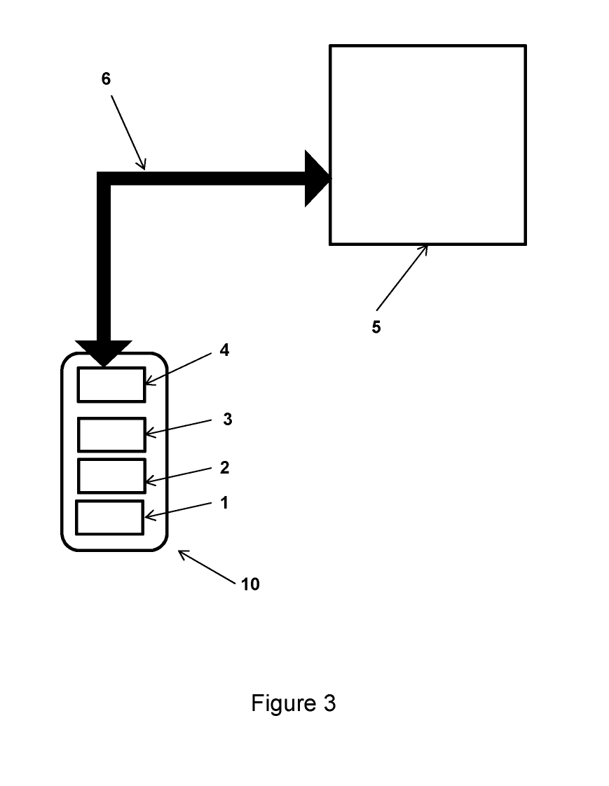

FIG. 3 illustrates schematically a client/server system adapted to implement embodiments of the invention; and

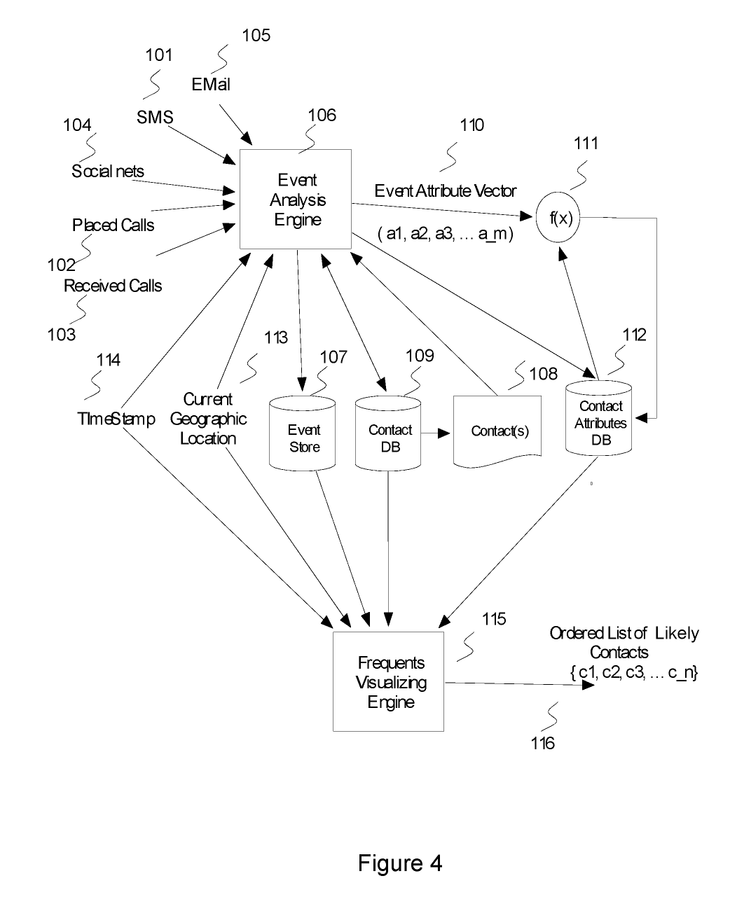

FIG. 4 provides a block diagram of a system implementing embodiments of the invention.

### DETAILED DESCRIPTION OF EMBODIMENTS

FIG. 3 shows schematically elements of a client/server system adapted for use in embodiments of the invention. A communication system 4 (which may include cellular telephony or networking capability, for example) in a mobile device 10 provides a communication channel 6 to a remote server 5. The mobile device comprises at least a processor 1, a memory 2 and a user interface 3 in addition. The memory 2 contains applications, which may include a phone book application. These applications are executed by the processor 1 and which may result in display or other interaction with the user interface 3.

FIG. 4 is a block diagram illustrating a phone book implemented according to an embodiment of the invention and various components in a system according to an embodiment of the invention. User and network events including sent and received SMS messages 101, placed calls 102 and received calls 103, social media messages 104, and email events 105, are received by the Event Analyzer Engine 106. The Event Analyzer takes each supplied event and appends the occurrence to an event store 107 as well as identifying the involved contact(s) 108. This identification is made by correlating the event content and participants with any specific contacts stored in the full contact list 109. The Event Analyzer further utilizes the contacts involved, geographic location 113, timestamp 114, communications terminal, communication mode, content of the message, day and time to compute a plurality of frequency characteristics using any suitable scoring mechanism such as a weighted sum. This results in an Event Attribute Vector 110, which represents a relevancy factor for each of these characteristics. The values of this vector are stored with the event history, as well as combined by combination function 111 with the previous values associated with the contact. These values are stored in the Contact Attribute Database 112 so that the current value can be quickly retrieved.

Further referring to FIG. 4, upon the terminal or station user invoking an aspect of a terminal or web-based application which requests the prioritized contacts, the Frequents Visualizing Engine 115 utilizes the timestamp 114, geographic location 113, and invoking application (not shown) to compose an event-matching vector (not shown). The resulting event-matching vector is compared against the contents of the Events Store 107 and the contents of the Contact Attribute Database 112 using any suitable scoring mechanism such as a weighted sum to produce an Ordered List of Likely Contacts 116. These contacts are displayed to the user such that the system-predicted contacts are displayed in the computed priority order.

The preferred embodiment of the system utilizes both terminal and server-based resources; however, the resulting events and contact attributes are synchronized such that the ordered contact list that considers all subscriber events are presented on any communication device that is enhanced by the invention.

The preferred embodiment of this invention uses a client-server model, however, the invention could be realized in isolation on an isolated mobile or stationary terminal. Embodiments of the invention provide a method to increase the speed and ease of looking up and then initiating a communication with someone from your mobile device. The system described above results in an Ordered List of Likely Contacts 116 which is subset list of people in your address book based on certain rules. These may include the number of times you interact with each of the people over a specific period of time, from a specific location, and/or at a specific time of day. The rules may take into account factors such as the number of times you make or receive calls (or send messages to or receive messages from) a person in the last 7 days, your physical location when the list is being displayed, and the time of day when the list is being displayed.

This feature is here termed the “Frequents” feature. FIG. 1 illustrates an embodiment of the invention in which contacts are displayed preferentially as “Frequents”. FIG. 2 shows another embodiment, in which contacts are displayed preferentially as “Frequents” but user presence information to indicate presence on a particular communication channel (such as availability for a SIP call) may also be displayed - this also may be another feature that is used to determine which contacts are displayed. Display of user presence is discussed in the applicant's earlier WO 2008/087428, the contents of which are incorporated by reference to the fullest extent permitted by applicable law.

1. A method of presenting contact information to a user of a communications device, comprising:
determining a current communications device state; and
ordering the contact information for presentation in dependence on one or more variables of the current communications device state.

2. A method as claimed in claim 1, wherein the communications device is a mobile telecommunications device.

3. A method as claimed in claim 1, wherein the current communications device state comprises one or more of the following parameters: current device location; current time of day; contact interaction history; and application invoking the contact information.

4. A method as claimed in claim 3, wherein the current communications device state comprises the contact interaction history and at least one other parameter.

5. A method as claimed in claim 3, wherein the contact interaction history comprises a history of interaction events with a contact and a communications device state associated with each interaction event.

6. A method as claimed in claim 5, wherein the communications device state associated with an interaction event comprises one or more of whether the interaction event was initiated at the communications device or by the contact; device location at the interaction event; time of day of the interaction event; and application associated with the interaction event.

7. A method as claimed in claim 5, wherein each interaction event in the history of interaction events is stored as a vector with an associated relevancy factor.

8. A method as claimed in claim 7, wherein ordering the contact information for presentation comprises calculating contact relevancy from the one or more variables of the current communications device state and the history of interaction events.

9. A method as claimed in claim 1, wherein at least ordering the contact information for presentation is performed remotely from the communications device.

10. A method of ordering contact information for a communications device comprising:
associating contact information with a plurality of events associated with the communications device;
determining a contact interaction history from the plurality of events and associated contact information; and
ordering contact information on the basis of the contact interaction history.

11. A method as claimed in claim 10, wherein the communications device is a mobile telecommunications device.

12. A method as claimed in claim 10, wherein ordering contact information is made in dependence on one or more variables of the current communications device state.

13. A method as claimed in claims 10 to 12, wherein the contact interaction history comprises a history of interaction events with a contact and a communications device state associated with each interaction event.

14. A method as claimed in claim 13, wherein the communications device state associated with an interaction event comprises one or more of whether the interaction event was initiated at the communications device or by the contact; device location at the interaction event;
time of day of the interaction event; and application associated with the interaction event.

15. A method as claimed in claim 13, wherein each interaction event in the history of interaction events is stored as a vector with an associated relevancy factor.

16. A method as claimed in claim 15, wherein ordering the contact information for presentation comprises calculating contact relevancy from the one or more variables of the current communications device state and the history of interaction events.

17. A method as claimed in claim 10, wherein at least ordering the contact information for presentation is performed remotely from the communications device.

18. A system for presenting contact information to a user of a communications device, comprising:
an event analyzer for analyzing events associated with the communications device and associating contact information with the events;
an event store for a contact interaction history comprising analyzed events and associated contact information; and
an ordering engine for ordering contact information on the basis of the contact interaction history.

19. A system as claimed in claim 18, wherein at least the event analyzer and the event store are located remotely from the communications device.

20. A system as claimed in claim 19, wherein the system comprises a server with a processor suitably programmed to provide the event analyzer and the ordering engine and a memory adapted to provide the event store, and further comprising a communication interface for receiving requests for ordered contact information from communications devices and for providing ordered contact information for communication devices.

21. A system as claimed in claim 20, wherein the system further comprises a client on a communication device adapted to communicate with the server to request and receive ordered contact information.

22. A system as claimed in claim 18, wherein the communications devices are mobile telecommunications devices.

23. A system as claimed in claim 18, wherein the ordering engine orders in dependence on one or more variables of the current communications device state.

24. A system as claimed in claim 18, wherein the contact interaction history comprises a history of interaction events with a contact and a communications device state associated with each interaction event.

25. A system as claimed in claim 24, wherein the communications device state associated with an interaction event comprises one or more of whether the interaction event was initiated at the communications device or by the contact; device location at the interaction event; time of day of the interaction event; and application associated with the interaction event.

26. A system as claimed in claim 24, wherein each interaction event in the history of interaction events is held in the event store as a vector with an associated relevancy factor.

27. A system as claimed in claim 26, wherein the ordering engine calculates contact relevancy from the one or more variables of the current communications device state and the history of interaction events.
